(19) United States
(12) Patent Application Publication
(10) Pub. No.: US 2015/0213138 A1
(43) Pub. Date: Jul. 30, 2015

(54) THING DEVICE BASED ON THING SEARCHING BROWSER, AND MASHUP METHOD BETWEEN THINGS

(71) Applicant: Electronics and Telecommunications Research Institute, Daejeon (KR)

(72) Inventors: BYUNG BOG LEE, Daejeon (KR); CHEOL SIG PYO, Daejeon (KR)

(21) Appl. No.: 14/604,095

(22) Filed: Jan. 23, 2015

(30) Foreign Application Priority Data
Jan. 24, 2014 (KR) 10-2014-0009154

(51) Int. Cl. G06F 17/30; H04L 29/08

(52) U.S. Cl. CPC G06F 17/30867; H04L 67/02

(57) ABSTRACT

A thing device based on a thing searching browser and a mashup method between the thing devices. The smart device according to an exemplary embodiment may include a thing searching browser to search and register a thing; a communications entity manager to provide, through the thing searching browser, an Open Application Programming Interface (Open API) that supports the thing to be searched and connected, and generate a communications entity and a communications entity profile based on the searched thing; and an entity communications channel manager to set a communications channel between the searched thing and the communications entity and transmit and receive data.

### CROSS-REFERENCE TO RELATED APPLICATION(S)

This application claims the benefit under 35 U.S.C. §119(a) of Korean Patent Application No. 10-2014-0009154, filed on Jan. 24, 2014, in the Korean Intellectual Property Office, the entire disclosure of which is incorporated herein by reference for all purposes.

### BACKGROUND

1. Field

The following description relates to a thing searching browser-based thing mashup technology for supporting a thing search, a thing connection control, and a data exchange between things based on the Internet of Things (IoT) that uses various types of wired and/or wireless communications media.

2. Description of the Related Art

The Internet of things (IoT) is an environment for sharing information by connecting things in life through wired and/or wireless networks. Information can be shared through the connections between things via networks of various fields, such as healthcare, remote meter reading, smart home, and a smart car, etc., as well as home appliances and electronic equipment. A heartbeat monitoring device that the American venture company Corventis Inc. developed, glasses from Google, and a FuelBand of Nike, etc. are also made based on such a technology.

For connecting things and sharing information, a thing searching browser-based thing mashup method is needed, which supports thing personalization and control services of searching and connecting things that perform various wired or wireless communications.

However, since the smartphone market has entered a saturated state, and the world s striving for the smartphones is turning its attention to a smart product market linked to smartphones and moving forward to new prospects, life patterns have changed these days from only living with the smartphones to living with various products connected to smartphones.

### SUMMARY

The following description relates to a thing device based on a thing searching browser and a mashup method between the thing devices for supporting thing personalization and control services by controlling search and connection of things that perform various wired or wireless communications.

In one general aspect, the thing device includes a thing searching browser to search and register a thing; a communications entity manager to provide, through the thing searching browser, an Open Application Programming Interface (Open API) that supports a thing to be searched and connected, and generate a communications entity and a communications entity profile based on the searched thing; and an entity communications channel manager to set a communications channel between a thing and a communications entity.

Other features and aspects may be apparent from the following detailed description, the drawings, and the claims.

### BRIEF DESCRIPTION OF THE DRAWINGS

FIG. 1 is a diagram illustrating a thing searching browser-based thing device having a thing mashup function according to an exemplary embodiment.

FIG. 2 is a diagram illustrating an example of a communications entity profile stored in database in FIG. 1 according to an exemplary embodiment.

FIG. 3 is a diagram illustrating an example of a main screen of a thing searching browser according to an exemplary embodiment.

FIG. 4 is a diagram illustrating an example of connecting a thing application (‘app’) to a searched thing according to an exemplary embodiment.

FIG. 5 is a diagram illustrating an example of a single-hop mashup method between things in a short distance according to an exemplary embodiment.

FIG. 6 is a diagram illustrating an example of a multi-hop mashup method between things in a long distance according to an exemplary embodiment.

FIG. 7 is a diagram illustrating an example of usage of a thing searching browser-based bridge or router in building a thing network infrastructure according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

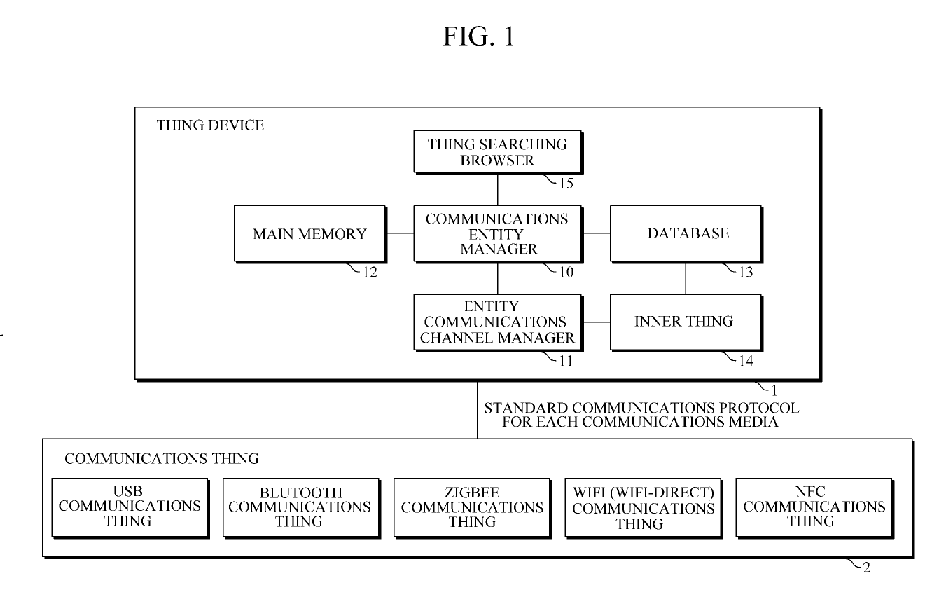

FIG. 1 is a diagram illustrating a thing searching browser-based thing device having a thing mashup function according to an exemplary embodiment.

Referring to FIG. 1, a thing device 1 includes a communications entity manager 10, an entity communications channel manager 11, a main memory 12, database 13, an inner thing 14, and a thing searching browser 15.

The thing device 1 may be a smart device as a device that is capable of providing and receiving a service to and from surrounding communications things 2 through wired or wireless communications. For example, the thing device 1 may be a smartphone, a smart car, and a smart TV, etc. Particularly, the thing device 1 may be a smartphone, and the surrounding is communications thing 2 may be a smart product. The smart product indicates a functional product that provides new services operating in association with an application (‘app’) of the smartphone.

For example, media of the wired or wireless communications may be Bluetooth®, ZigBee, near field communication (NFC), WiFi or WiFi Direct, infrared rays (IR), a headphone jack, an SMS or MMS, and an IP packet network, etc. FIG. 1 illustrates as examples of the NFC, such as USB, Bluetooth®, ZibBee, WiFi, and NFC, etc., which are not, however, limited thereto, and both of the NFC and long-distance communications may be used.

The communications entity manager 10 provides systematized formal Open Application Programming Interfaces (Open APIs) so as to easily search, access, and control the inner thing 14 the same as an internal sensor located in the thing device 1 or an exterior thing same as an exterior sensor.

The thing searching browser 15 is software being installed in the thing device 1 and executed, and supports a thing virtualization service for virtualizing and personalizing surrounding things in life as the things within the thing device 1. The thing searching browser 15 supports a thing mashup for building a mashup for the thing through Click and Type by the thing device 1 so as to perform a thing search, a thing registration, a thing connection control, and a data exchange between things, etc.

For example, the thing searching browser 15 searches a WiFi Access Point (AP), acquires an IP address and a service set identifier (SSID) of the WiFi AP, and registers the interest AP to the smart device. The thing searching browser 15 searches identifiers and names of the surrounding things. The smart device with Bluetooth® communications media searches a thing is identifier (MAC address) and a name of a Bluetooth® communications thing. The smart device acquires vendor identifiers (IDs) and produce IDs, such as CP21xx or FTDI, etc., from a USB communications thing that is connected to the smart device with a USB-to-UART circle type, and assigns the thing ID and the name of CP21xx to CP21xx, or the thing ID and the name of FTDI to FTDI. An NFC reader searches a thing identifier and a name from the NFC communications thing and assigns the thing identifier and the name to NFC. From an inner thing, such as Built-in Sensor, which is located in the inside of the smart device, the NFC reader searches a thing identifier and a name and assigns the thing identifier and the name to the a sensor name that a relevant vendor gives.

The identifiers and names of the searched things are displayed on a screen through a graphic interface of the thing searching browser 15. Here, if a user clicks once the thing displayed through the graphic interface, the communications entity manager 10 generates a communications entity to register the communications entity to main memory 12, and generates a communications entity profile, which is required information for setting a communications path between the thing and the communications entity, to store the communications entity profile in the database 13. The communications entity indicates an entity acquired after a real-world thing is projected in virtual space of the smart device.

If a thing is searched due to a thing searching command by the thing searching browser 15, a thing app is registered to the searched thing. The thing app is a program for analyzing data received from the thing and requesting a command to the thing. The registered thing app accesses the communications entity generated in the main memory 12, sets a communications path between the thing and the communications entity, activate or deactivate the communications path, and is programmed using Open APIs provided by the communications entity manager 10 to acquire the data transmitted by the thing from a message queue of the entity.

The communications entity manager 10 manages the communications entity with respect to the thing that has been registered after being virtualized and personalized. When there is a thing personalization request, the communications entity manager 10 generates the communications entity in the main memory 12. In addition, an access pointer of the communications entity generated in the main memory 12 is added to a communications entity list of the communications entity manager 10. Thus, the communications entity manager 10 may access all the communications entities by using the access pointer.

With respect to the registered thing, the communications entity profile stored in the database 13 includes a thing identifier, a thing name, a communications driver name, a communications media type, a communications path setting state, a load label of a thing-related thing app, and a package name of the thing app. Since the thing stated in the communications entity profile is a final interest target of a user of the thing device 1, if the communications entity manager 10 starts or re-start its operation, the communications entity manager 10 automatically generate the communications entity in the main memory 12.

To a discoverable device object list by searching surrounding things for each of the communications media, the entity communications channel manager 11 adds a device object that is a peer-to-peer (P2P) entity which states an identifier and a name of the searched thing. In addition, an access pointer of the device object is added to the device object list of the entity is communications channel manager 11. The entity communications channel manager 11 updates the state value of the device object and the communications path setting state of the communications entity profile to a ‘connected’ or ‘disconnected’ state when the communications channel is connected or disconnected between the communications entity and the thing. The device object belongs to the peer-to-peer entity that communicates with the thing.

In an exemplary embodiment, a process of generating the entity is as follows.

1) While providing the thing identifier and a communications media type parameter that the thing uses, the thing searching browser 15 or the thing app calls an Open API for personalizing a thing to the communications entity manager 10.

2) The communications entity manager 10 requests checking whether the thing device object exists in the discoverable device object list to the entity communications channel manager 11 by using the thing identifier and the communications media type. If the thing device object does not exist in the discoverable device object list, the communications entity manager 10 requests a search of the surrounding things to the entity communications channel manager 11, and updates the discoverable device object list.

3) If the thing device object does not exist in the updated discoverable device object list, the communications entity manager 10 handles the thing personalization request to fail.

4) If the thing device object exists in the discoverable device object list, the communications entity manager 10 generates the communications entity as well as information on the thing identifier and the communications media type in the main memory 12. An access is pointer of the generated entity is added to the communications entity list of the communications entity manager 10.

5) The communications entity generated through the processes above has an internal message queue that stores data to be received from a thing in physical space.

6) The communications entity manager 10 transfers, to the database 13, the thing identifier, the thing name, the driver name, the communications path setting state (‘disconnected’), a load label of the thing-related thing app, and a package name parameter of the thing app, and requests generation of the communications entity profile of the communications entity.

In an exemplary embodiment, a process of setting the communications channel between the thing and the communications entity is as follows.

1) While providing the thing identifier and the communications media type parameter, the thing app calls an Open API for setting a communications channel for data exchange to the communications entity manager 10.

2) On the communications entity list that the communications entity manager 10 manages, the communications entity manager 10 searches the communications entity including the same as the transferred communications thing identifier.

3) The communications entity manager 10 requests the communications channel setting between the searched communications entity and the thing to the entity communications channel manager 11.

4) If the channel is successfully set, the entity communications channel manager 11 is updates the communications path setting state of the communications entity profile to the ‘connected’ state.

In an exemplary embodiment, a process of activating the communications path between the thing and the communications entity is as follows.

1) While providing a thing identifier and a data parameter, the thing app calls an Open API for commanding a communications path to be activated to the communications entity manager 10.

2) On the communications entity list that the communications entity manager 10 manages, the communications entity manager 10 searches the communications entity including the same as the transferred communications thing identifier.

3) The communications entity manager 10 requests an activation of the communications path between the searched communications entity and the thing to the entity communications channel manager 11.

4) If the entity communications channel manager 11 succeeds in activating the communications path, data transmitted from the thing begins to be stored in an internal message queue.

In an exemplary embodiment, a process of receiving data by the thing app is as follows.

1) While providing the thing identifier and the data parameter, the thing app calls an Open API for receiving data to the communications entity manager 10.

2) On the communications entity list that the communications entity manager 10 manages, the communications entity manager 10 searches the communications entity including the same as the transferred communications thing identifier.

3) The communications entity manager 10 calls a behavior for receiving data of the searched communications entity. Here, the data is transferred from the message queue of the communications entity to the thing app.

In an exemplary embodiment, a process of transmitting data by the thing app is as follows

1) While providing the thing identifier and the data parameter, the thing app calls an Open API for transmitting data to the communications entity manager 10.

2) On the communications entity list that the communications entity manager 10 manages, the communications entity manager 10 searches the communications entity including the same as the transferred communications thing identifier.

3) The communications entity manager 10 calls a behavior for transmitting data of the searched communications entity.

4) The data is transferred to the thing through the entity communications channel manager 11 that the communications entity uses.

In an exemplary embodiment, a process of deactivating the communications path between the thing and the communications entity is as follows.

1) While providing the thing identifier and the data parameter, the thing app calls an Open API for deactivating a communications path to the communications entity manager 10.

2) On the communications entity list that the communications entity manager 10 manages, the communications entity manager 10 searches the communications entity including the same as the transferred communications thing identifier.

3) The communications entity manager 10 requests deactivation of the communications path between the searched communications entity and the thing to the entity communications channel manager 11.

4) If the entity communications channel manager 11 succeeds in deactivating the communications path, the entity communications channel manager 11 updates the communications path setting state of the communications entity profile to a ‘disconnected’ state.

In an exemplary embodiment, a process of deleting the communications entity is as follows.

1) While providing the thing identifier and the data parameter, the thing app calls an Open API for deleting a communications entity to the communications entity manager 10.

2) On the communications entity list that the communications entity manager 10 manages, the communications entity manager 10 searches the communications entity including the same as the transferred communications thing identifier.

3) The communications entity manager 10 requests deactivation of the communications path between the searched communications entity and the thing to the entity communications channel manager 11.

4) If the entity communications channel manager 11 succeeds in deactivating the communications path, the entity communications channel manager 11 deletes a device object including the same name as the thing identifier from the device object list of the entity communications channel manager 11.

5) The communications entity manager 10 removes the communications entity including the same name as the thing identifier from the main memory 12, and deletes the access pointer of the communications entity from the communications entity list of the communications entity manager 10

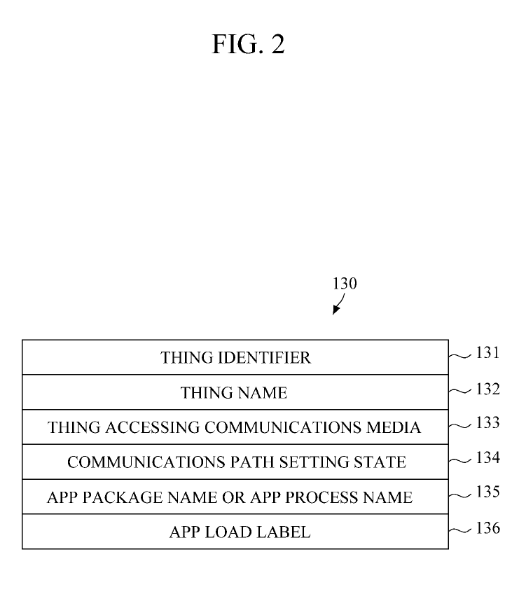

FIG. 2 is a diagram illustrating an example of a communications entity profile stored in database in FIG. 1 according to an exemplary embodiment.

Referring to FIGS. 1 and 2, a communications entity profile 130 includes a thing identifier 131 for identifying a communications entity registered within a thing device, a thing name 132, a thing accessing communications media 133, a communications path setting state 134, a thing app package or app process name 135, and a load label 136 of a thing-related thing app, etc. The communications entity profile 130 may be searched through an Open API that is provided by a communications entity manager 10. The thing accessing communications media 133 may be, for example, infrared rays (IR), USB, WiFi, a headphone jack, Bluetooth®, and an internal bus, etc. The communications path setting state 134 may be, for example, ‘ready’, ‘disconnected’, and ‘connected’ states, etc.

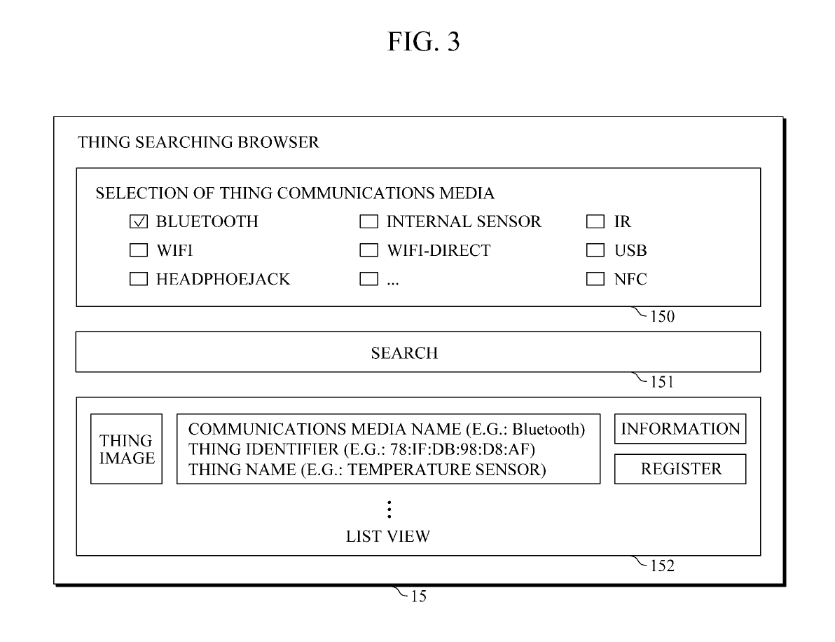

FIG. 3 is a diagram illustrating an example of a main screen of a thing searching browser according to an exemplary embodiment.

Referring to FIG. 3, a main screen of a thing searching browser includes a selection menu 150 for selecting thing communications media for a user, a search menu 151 for requiring a search of the communications entity corresponding to the thing communications media selected is through the selection menu 150, and a list view 152 that shows a list of the searched things.

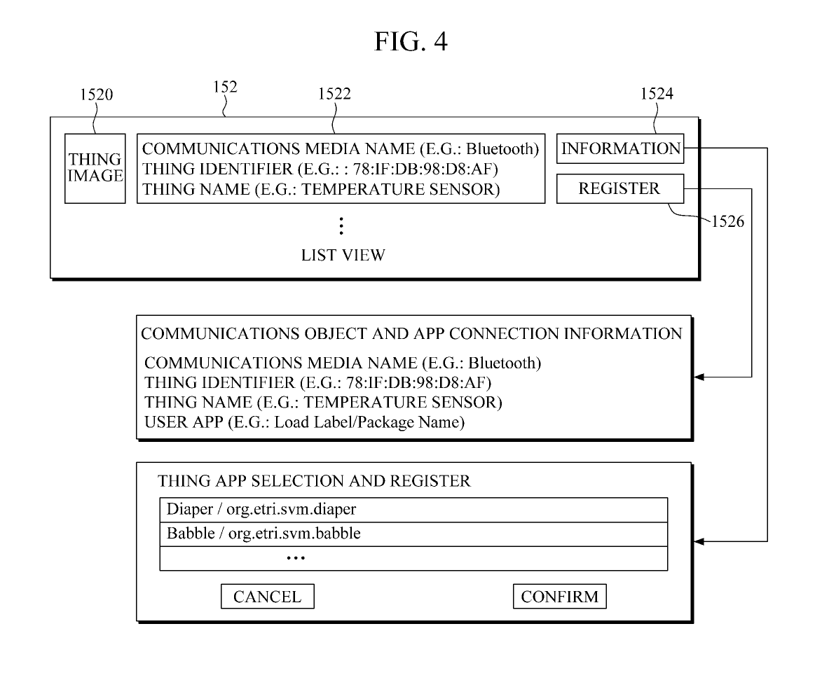

FIG. 4 is a diagram illustrating an example of connecting a thing app to a searched thing according to an exemplary embodiment.

Referring to FIGS. 3 and 4, a list view 152 includes a thing image menu 1520; a text view 1522 including a communications media name, a thing identifier, and a thing name; an information menu 1524 showing information on the thing app connected to the communications entity; and a registration menu 1526 connecting the thing app to the searched thing and commanding the thing to be generated into the communications entity.

If a user selects the registration menu 1526, lists of the thing app that is installed in advance in a thing device are searched and added to the thing app selecting and registering spinner list. If the user selects a specific thing app from the thing app selection and registration spinner list, the communications entity is generated in a main memory of the thing device, and a communications entity profile is generated in database. If the selection and registration of the thing app is completed, the registration thing app is executed whenever the user selects the thing image menu 1520 of the thing.

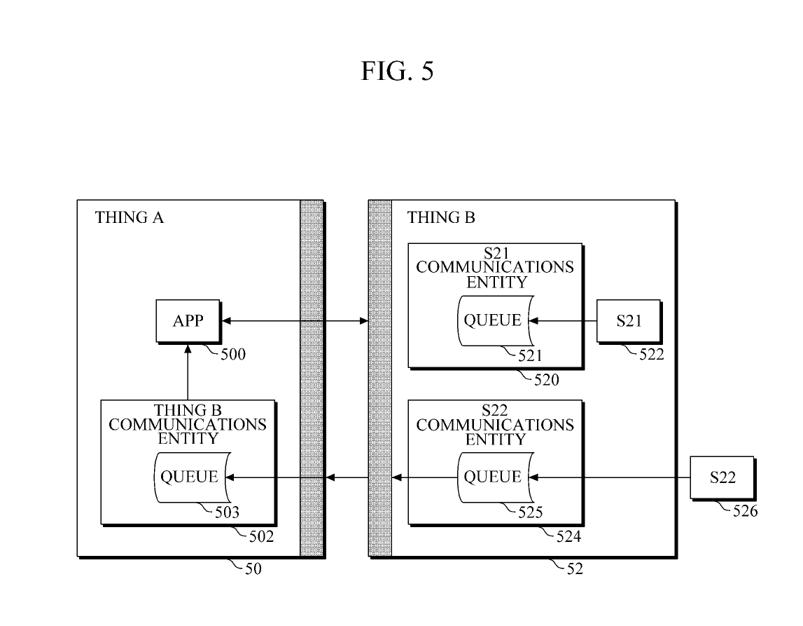

FIG. 5 is a diagram illustrating an example of a single-hop mashup method between things in a short distance according to an exemplary embodiment.

Referring to FIG. 5, it is assumed that NFC, such as WiFi-Direct or Bluetooth®, etc., may be used between a thing A 50 and a thing B 52. Here, it is assumed that the thing A 50 generates and manages a thing B communications entity 502 and a thing B communications is entity profile in the thing A 50 as the thing A 50 recognizes the thing B 52 as a thing with a composite sensor. It is assumed that the thing B 52 generates and manages an S22 communications entity 524 and an S22 communications entity profile in the thing B 52 as the thing B 52 recognizes S22 526, which is an external sensor, as a thing; and that the thing B 52 generates and manages an S21 communications entity 520 and an S21 communications entity profile in the thing B 52 as the thing B 52 recognizes an S21 522, which is an internal sensor, as a thing.

In describing an NFC process between the thing A 50 and the thing B 52 below, a thing A app 500 requests registration of the thing B 52 to a thing searching browser of the thing A 50 so as to build a mashup of the searched thing B 52.

The thing A 50 generates the thing B communications entity 502 and the thing B communications entity profile as the thing A 50, which has received the registration request of the thing B 52 through the thing A app 500, recognizes the thing B 52 as a thing with a composite sensor.

If the thing A app 500 requests communications channel setting and activation between the thing and the communications entity to the communications entity manager, the thing A 50 sets a communications path between the thing B 52 and the thing B communications entity 502 generated in the thing A 50, and activates the communications path to enable data to be exchanged, by using an entity communications channel manager of the thing B 52.

If the thing A 50 requests, to the thing B 52, communications entity profile information on the things personalized by the thing B 52, the thing B 52 inputs the communications entity profile to a queue 503 of the thing B communications entity 502 in the thing A 50, and the thing A 50 receives, from a user, selection of a thing, e.g., S22 526, in which a user has an interest, from the communications entity profile that is read from the queue 503. When the thing A 50 informs information on the selected thing S22 526 to the thing B 52, the thing B 52 sets and activates the communications channel connected to the thing S22 526. When data transmitted by the thing S22 526 is transferred to a queue 525 of the S22 communications entity 524 in the thing B 52, the thing B 52 reads the data from the queue 525 and inputs the data to the queue 503 of the of the thing B communications entity 502 in the thing A 50, and the thing A app 500 reads the data from the queue 503 of the thing B communications entity 502. However, the mashup process between things in a short distance, which is described with reference to FIG. 5, is one example for better understanding and is not limited thereto.

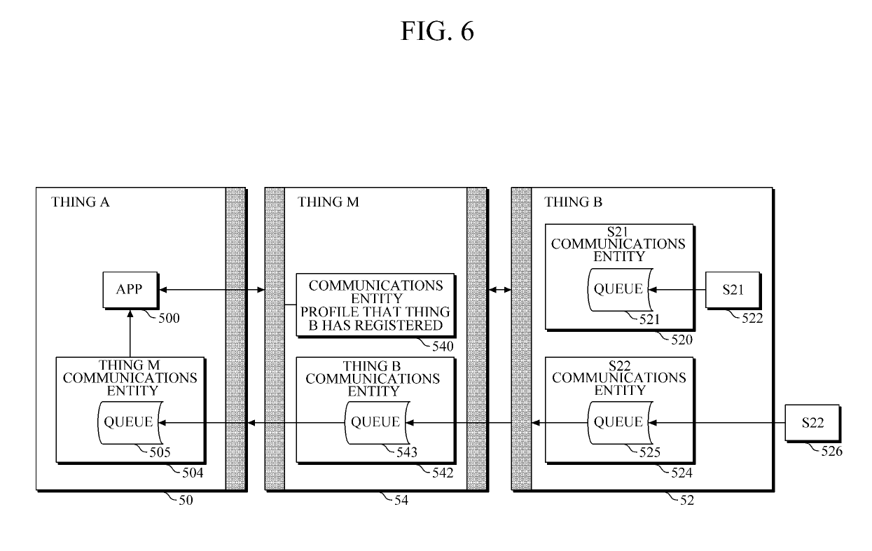

FIG. 6 is a diagram illustrating an example of a multi-hop mashup method between things in a long distance according to an exemplary embodiment.

Referring to FIG. 6, it is assumed that long-distance communications may be performed between a thing A 50 and a thing B 52 through a thing M 54. The thing M 54 may be a network device, such as a bridge or a router, etc. For better understanding, locations of things for the long-distance communications may be, for example, as follows: the thing A 50 is located in Seoul; the thing M 54, in Daejeon; and the thing B 52, in Busan. The thing A 50 recognizes the thing B 52 as a thing with a composite sensor, and generates and manages a thing M communications entity 504 and a thing M communications entity profile in the thing A 50. In a case in which the thing B 52 registers an entity profile list to the thing M 54, the thing M 54 is recognizes the thing B 52 as a thing with a composite sensor and generates and manages a thing B communications entity 542 and a thing B communications entity profile in the thing M 54. So as to open to other things via the thing M 54, the thing B 52 registers the communications entity profile list managed by itself to the thing M 54.

In describing a long-distance communications process between the thing A 50 and the thing B 52 below, so as to build a mashup of the thing B 52 located in a long distance, the thing A app 500 recognizes the thing M 54 and generates and manages the thing M communication entity 504 and the thing M communication entity profile in the thing A 50.

If the thing A app 500 requests communications channel setting and activation between the thing M communications entity 504 and the thing M 54 to the communications entity manager, the thing A 50 sets a communications path between the thing M 54 and the thing M communications entity 504 generated in the thing A 50, and activates the communications path to enable data to be exchanged, by using an entity communications channel manager.

Then, if the thing A 50 requests information on the thing B 52, the thing M 54 reads the information on the thing B communications entity profile, which the thing B 52 has registered in advance, and inputs the information to a queue 505 of the thing M communications entity 504 in the thing A 50.

The thing M 54 sets a communications path between the thing B 52 and the thing B communications entity 542 generated in the thing M 54, and activates the communications path to enable data to be exchanged, by using the entity communications channel manager.

When the thing A 50 receives, from a user, selection of a thing, e.g., S22 526, in which a user has an interest, from the communications entity profile that is read from the queue 505 of the thing B communications entity 504. The thing A 50 informs information on the selected thing S22 526 to the thing M 54, and the thing M 54 informs the information to the thing B 52 again so as to perform communications channel setting and activation between the S22 communications entity 524 of the thing B 52 and the thing S22 526.

If the data transmitted by the thing S22 526 is transferred to the queue 525 of the S22 communications entity 524 in the thing B 52, the thing B 52 reads the data from the queue 525 of the S22 communications entity and inputs the data to a queue 543 of the thing B communications entity in the thing M 54; the thing M 54 reads the data from the queue 543 of the thing B communications entity 542 and inputs the data to the queue 505 of the thing M communications entity 504 in the thing A; and the thing A app 500 reads the data from the queue 505 of the thing M communications entity 504. However, the mashup process between the things in a long distance, which is described with reference to FIG. 6, is one example for better understanding and is not limited thereto.

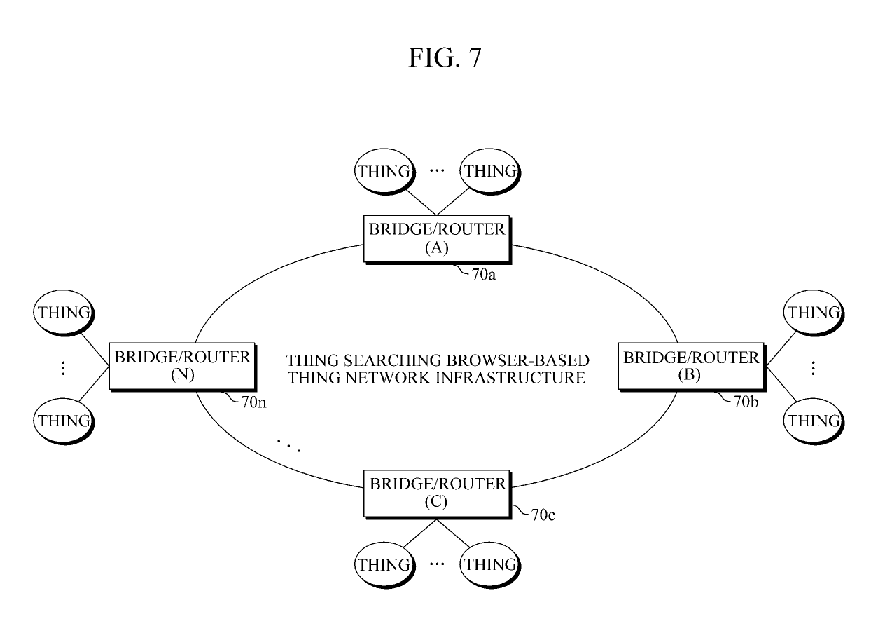

FIG. 7 is a diagram illustrating an example of usage of a thing searching browser-based bridge or router in building a thing network infrastructure according to an exemplary embodiment.

Referring to FIG. 7, as a thing network infrastructure is built by using a bridge or router 70a, 70b, 70c, . . . , 70n, long-distance communications is possible between things where NFC is not possible.

In an exemplary embodiment, since the thing searching browser executes functions of thing searching, connection controlling, and data exchanging, which were performed with the existing hundreds of lines instead of an app, an app for a smart product can be developed only with decades of lines. Thus, with only one idea, anyone can easily quickly start one's own business for the smart product at a low cost, and also provide an environment for sharing information through a mashup between things.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A thing device based on a thing searching browser, comprising:
a thing searching browser configured to search and register a thing;
s a communications entity manager configured to provide, through the thing searching browser, an Open Application Programming Interface (Open API) that supports the thing to be searched and connected, and generate a communications entity and a communications entity profile based on the searched thing; and
an entity communications channel manager configured to set a communications channel between the searched thing and the communications entity and transmit and receive data.

2. The thing device of claim 1, wherein the thing searching browser is configured to connect a thing app to the searched thing, wherein the thing app is configured to access the communications entity, set and activate or deactivate the communications path between the thing is and the communications entity, and be programmed using the Open API provided by the communications entity manager so as to acquire, from the communications entity, the data transmitted by the thing.

3. The thing device of claim 1, wherein the communications entity manager is configured to manage the communications entity that is registered after being virtualized and personalized in the thing device, and add an access pointer of the communications entity to a communications entity list, wherein the access pointer is accessible to the communications entity.

4. The thing device of claim 1, wherein the communications entity is an object acquired after a real-world thing is projected in virtual space of the thing device.

5. The thing device of claim 1, wherein the communications entity profile comprises at least one of, with respect to the registered thing:
a thing identifier, a thing name, a communications driver name, a type of communications media, a communications path setting state, a load label of a thing app associated with the thing, and a package name of the thing app.

6. The thing device of claim 1, wherein the entity communications channel manager is configured to add a device object with an identifier and name of the searched object to a list of discoverable device objects by searching surrounding things for each of communications media, wherein the device object is a P2P entity communicating with things, and add an access pointer of the device object to a device object list.

7. The thing device of claim 1, wherein the thing searching browser provides a user interface, which comprises a selection menu for selecting thing communications media by a user, a search menu for requiring a search of the communications entity included in the thing communications media selected by the user through the selection menu, and a list view showing a list of the searched communications entity of the communications entity.

8. A mashup method between things by a thing device, the mashup method comprising:
searching a thing around the thing device through a thing searching browser;
a communications entity manager generating and managing a communications entity and a communications entity profile, which correspond to the searched thing; and
an entity communications channel manager setting a communications channel between the searched thing and the communications entity and activating a communications path.

9. The mashup method of claim 8, wherein the generating and managing of the communications entity and the communications entity profile comprises:
the thing searching browser or a thing app of the thing device calling an Open API provided by the communications entity manager while transmitting, to the communications entity manager, a thing identifier and a communications media type parameter that the thing uses;
the communications entity manager requesting, to the entity communications channel manager, a confirmation of whether a device object of the thing exists in a list of discoverable devices by using the thing identifier and the communications media type;
is in response to the existence of the device object of the thing in the list of discoverable devices, the communications entity manager generating and registering the communications entity and generating an internal message queue with data, received from the thing, to be stored in the communications entity; and
the communications entity manager generating and storing the communications entity profile.

10. The mashup method of claim 9, wherein the generating and managing of the communications entity and the communications entity profile comprises:
in response to no existence of the device object of the thing in the list of discoverable devices, the communications entity manager requesting a search of surrounding things to the entity communications channel manager, updating the list of discoverable devices, and in response to no existence of the device object of the thing in the updated list of discoverable devices, handling a request for a thing personalization to failure.

11. The mashup method of claim 8, wherein the setting of the communications channel, and the activating of the communications path comprise:
a thing app calling an Open API for setting a communications channel for data exchange while transmitting a thing identifier and a communications media type parameter to the communications entity manager, wherein the Open API is provided by the communications entity manager;
the communications entity manager searching the communications entity with a is same as the transmitted thing identifier in a communications entity list that is managed by the communications entity manager;
the communications entity manager requesting a setting of the communications channel between the searched communications entity and the thing to the entity communications channel manager; and
the entity communications channel manager updating a communications path setting state of the communications entity profile into a ‘connected’ state.

12. The mashup method of claim 8, wherein the setting of the communications channel, and the activating of the communications path comprise:
a thing app calling an Open API for commanding the communications path to be activated while transmitting a thing identifier and a data parameter to the communications entity manager, wherein the Open API is provided by the communications entity manager;
the communications entity manager searching the communications entity with a same as the transmitted thing identifier in a communications entity list managed by the communications entity manager;
the communications entity manager requesting activation of the communications path between the searched communications entity and the thing to the entity communications channel manager; and
in response to the communications path being activated by the entity communications channel manager, beginning to store data transmitted by the thing in an internal message queue of the communications entity.

13. The mashup method of claim 8, comprising:
receiving data from the thing corresponding to the generated communications entity.

14. The mashup method of claim 13, wherein the receiving of the data comprises:
a thing app calling an Open API for receiving data provided by the communications entity manager while transmitting a thing identifier and a data parameter to the communications entity manager;
the communications entity manager searching the communications entity with a same as the transmitted thing identifier in a communications entity list managed by the communications entity manager; and
the entity communications channel manager transferring data to a thing app from a message queue of the communications entity.

15. The mashup method of claim 8, comprising:
transmitting data to the thing corresponding to the generated communications entity.

16. The mashup method of claim 15, wherein the transmitting of the data comprises:
a thing app calling an Open API for transmitting data provided by the communications entity manager while transmitting a thing identifier and a data parameter to the communications entity manager;
the communications entity manager searching the communications entity with a same as the transmitted thing identifier in a communications entity list managed by the communications entity manager; and
transmitting the data to the thing through the entity communications channel manager used by the searched communications entity.

17. A thing mashup method between thing devices, comprising:
a first thing device searching a second thing device and generating a second communications entity and a second communications entity profile in the first thing device;
the first thing device setting and activating a communications path between a second communications entity, generated in the first thing device, and the second thing device; and
transmitting and receiving data through the activated communications path.

18. The thing mashup method of claim 17, wherein the transmitting and receiving of the data comprises:
in response to the first thing device requesting information of a communications entity profile to the second thing device in response to the activation of the communications path, wherein the information is regarding things personalized by the second thing device, the second thing device inputting the communications entity profile to a queue of the second communications entity in the first thing device, and the first thing device selecting, by a user, an interest thing from the communications entity profile that is read from the queue of the second communications entity; and
in response to the first thing device notifying the selected thing to the second thing device, the second thing device setting and activating the communications channel connected to the selected thing.

19. The thing mashup method of claim 18, wherein the transmitting and receiving of the data comprises:
in response to data being transferred from the thing selected by the user to a queue of a communications entity associated with the selected thing in the second thing device, the second thing device reading the data from the queue of the communications entity associated with the selected thing and inputting the data to the queue of the second communications entity in the first thing device; and
the first thing device reading the data from the queue of the second communications entity.
